(19) United States
(12) Patent Application Publication
(10) Pub. No.: US 2018/0368402 A1
(43) Pub. Date: Dec. 27, 2018

(54) HIGH STABILITY NON-IONIC N-VINYL BUTYROLACTAM IODINE AND PREPARATION METHOD THEREFOR

(71) Applicant: SHANGHAI YUKING WATER SOLUBLE MATERIAL TECH CO., LTD., Shanghai (CN)

(72) Inventors: Yu WANG, Shanghai (CN); Zhan CHEN, Shanghai (CN)

(21) Appl. No.: 16/126,206

(22) Filed: Sep. 10, 2018

Related U.S. Application Data
(63) Continuation of application No. 13/978,367, filed on Jul. 3, 2013.

(30) Foreign Application Priority Data
Jan. 7, 2011 (CN) 201110002771.0

(51) Int. Cl. A01N 43/36; A01N 59/12; A01N 25/02; A01N 25/22

(52) U.S. Cl. CPC A01N 43/36; A01N 25/22; A01N 25/02; A01N 59/12

(57) ABSTRACT

A preparation method of a high-stability non-ionic N-vinyl butyrolactam iodine solution is provided in which high-stability non-ionic N-vinyl butyrolactam iodine is dissolved in water, then citric acid, at least one iodine ion stabilizing agent, at least one non-ionic surfactant and at least one emulsifier are added, then the pH is adjusted to 5 with at least one pH adjusting agent, so as to prepare the high-stable non-ionic N-vinyl butyrolactam iodine solution. The high-stability non-ionic N-vinyl butyrolactam iodine is formed by complexing PVP-K30, iodine and at least one grinding aid at a temperature of 60° C-90° C., the high-stability non-ionic N-vinyl butyrolactam iodine solution prepared by the above mentioned method is also provided, the stability of the high-stable non-ionic N-vinyl butyrolactam iodine solution is high, thereby facilitating long-term storage and use, thus the high-stable non-ionic N-vinyl butyrolactam iodine solution is suitable for large-scale popularization.

### RELATED APPLICATIONS

This application is a continuation of U.S. Utility application Ser. No. 13/978,367 filed Jul. 3, 2013; that in turn is a US National Phase filing of PCT/CN11/78578 filed August 18, 2011; the contents of which are hereby incorporated by reference.

### FIELD OF TECHNOLOGY

The present invention relates to the technical field of preparing solutions, especially to the technical field of preparing non-ionic N-vinyl butyrolactam iodine solutions, in particular to a high-stable non-ionic N-vinyl butyrolactam iodine solution and preparation method thereof.

### DESCRIPTION OF RELATED ARTS

Non-ionic N-vinyl butyrolactam iodine (PVP-I) is a kind of amorphous powder having a yellowish-brown to reddish-brown color, an unshaped iodine complex formed by complexing non-ionic N-vinyl butyrolactam (PVP) with iodine, PVP-I for short, and an indophor. PVP-I is an excellent disinfectant, as documented in the 1990 edition of the Chinese Pharmacopoeia. PVP-I can maintain a bactericidal power for a longer time, is a broad-spectrum strong disinfectant, has a relatively strong role in killing viruses, bacteria, fungi and mold spores, and is approved by the Chinese Pharmacopoeia as a sanitizer that can be used directly on human bodies.

PVP-I is easily dissolved in water, does not cause irritation, allergy and poisoning to skin and mucous membranes, and thus PVP-I has a very good evaluation both domestically and abroad. PVP-I not only can be used as an aqueous solution, but also can be used in a solid form in some special applications. This allows the PVP-I complex to be widely used in sterilization, disinfection of various fields, expands the application range of iodine, and the PVP-I complex can be widely applied in the disinfection of domestic hospitals. At the present stage, the most widely used solution agent is the PVPI solution in clinic, but the stability of the PVP-I disinfectant produced by traditional methods is not ideal. During the storage of PVP-I, due to easy decomposition and sublimation, the content of its available iodine is decreased slightly, and the PVP-I cannot meet the quality standard of the required usage. In addition, PVP-I is more unstable especially in summer, which makes long-term storage and use of the disinfectant problematic.

Therefore, there is an urgent need to provide a high-stable non-ionic N-vinyl butyrolactam iodine solution, whose stability is high, thereby facilitating long-term storage and use.

### SUMMARY OF THE INVENTION

Aspects of the present invention generally pertain to a high-stability non-ionic N-vinyl butyrolactam iodine solution and method of preparation thereof. The stability of the high-stability non-ionic N-vinyl butyrolactam iodine solution is high, thereby facilitating long-term storage and use, and thus the high-stability non-ionic N-vinyl butyrolactam iodine solution is suitable for large-scale popularization.

In order to realize the above aims, in a first aspect of the present invention, a preparation method of a high-stability non-ionic N-vinyl butyrolactam iodine solution is provided and characterized in that, high-stability non-ionic N-vinyl butyrolactam iodine meeting a condition that the degradation rate after the high-stability non-ionic N-vinyl butyrolactam iodine is positioned at 85° C. for 15 hours is less than 6.0% is dissolved in water, then citric acid, at least one iodine ion stabilizing agent, at least one non-ionic surfactant, and at least one emulsifier are added, then the pH is adjusted to 5 with at least one pH adjusting agent, so as to prepare the high-stability non-ionic N-vinyl butyrolactam iodine solution.

The iodine ion stabilizing agent, the non-ionic surfactant, the emulsifier, the pH adjusting agent and the high-stability non-ionic N-vinyl butyrolactam iodine can be any suitable agents. Preferably, the iodine ion stabilizing agent is potassium iodate, the non-ionic surfactant is Tween 20, the emulsifier is polyethylene glycol 200, and the pH adjusting agent is sodium hydroxide.

A person skilled in the art can add suitable amounts of the high-stability non-ionic N-vinyl butyrolactam iodine, the citric acid, the iodine ion stabilizing agent, the non-ionic surfactant, and the emulsifier according to their level of experience. Preferably, the high-stability non-ionic N-vinyl butyrolactam iodine is 20 g, the citric acid is 0.5-5.0 g, the iodine ion stabilizing agent is 0.1-1.0 g, the non-ionic surfactant is 0.1-1.0 g, and the emulsifier is 0.5-5.0 g.

The high-stability non-ionic N-vinyl butyrolactam iodine can be provided in any suitable manner. Preferably, the high-stability non-ionic N-vinyl butyrolactam iodine is formed by complexing PVP-K30, iodine, and at least one grinding aid at a temperature of 60° C-90° C. For example, the high-stability non-ionic N-vinyl butyrolactam iodine can be complexed by grinding at a high speed of 20000-30000 r/min for 50 to 60 seconds.

The grinding aid can adopt any suitable grinding aid. More preferably, the grinding aid is one or more selected from the group of sodium chloride, sodium citrate, sodium carbonate, and sodium phosphate.

The person skilled in the art can add suitable amounts of PVP-K30, the iodine, and the grinding aid according to their level of experience. Preferably, the PVP-K30 is 46-47g, the iodine is 7 g, and the grinding aid is 0.19-0.27 g.

The high-stability non-ionic N-vinyl butyrolactam iodine can be any high-stability non-ionic N-vinyl butyrolactam iodine meeting a condition that the degradation rate after the high-stability non-ionic N-vinyl butyrolactam iodine is positioned at 85° C. for 15 hours is less than 6.0%. Preferably, the high-stability non-ionic N-vinyl butyrolactam iodine is YuKing®-PVPI (H) prepared by Shanghai Yu King New Material Technology Development Co., Ltd.,

In a second aspect of the present invention, a high-stability non-ionic N-vinyl butyrolactam iodine solution is provided and characterized in that, the high-stability non-ionic N-vinyl butyrolactam iodine solution is obtained by the preparation method of a high-stability non-ionic N-vinyl butyrolactam iodine solution mentioned above.

The beneficial effects of the present invention are as follows:

1. The present invention prepares the high-stability non-ionic N-vinyl butyrolactam iodine solution by dissolving high-stability non-ionic N-vinyl butyrolactam iodine in water, adding citric acid, at least one iodine ion stabilizing agent, at least one non-ionic surfactant, and at least one emulsifier, adjusting the pH to 5 with at least one pH adjusting agent, and the stability of the high-stability non-ionic N-vinyl butyrolactam iodine solution prepared is high, thereby facilitating long-term storage and use, thus the high-stability non-ionic N-vinyl butyrolactam iodine solution is suitable for large-scale popularization.
2. The present invention does not use the conventional PVPI, and instead uses the high-stability non-ionic N-vinyl butyrolactam iodine formed by complexing PVP-K30, iodine and at least one grinding aid at a temperature of 60° C-90° C., such as the YuKing®-PVPI (H) product prepared by Shanghai Yu King New Material Technology Development Co., Ltd. Compared with the conventional PVPI, the stability of the YuKing®-PVPI (H) is high, so as to contribute to the stability of the high-stability non-ionic N-vinyl butyrolactam iodine solution being prepared.

### DETAILED DESCRIPTION OF THE PREFERRED EMBODIMENT

In order to understand the technical content of the present invention clearly, the present invention is further exemplified with reference to the following examples. The raw materials and equipment involved in the examples are as follows:

Experimental materials: ordinary PVPI (YuKing®-PVPI (C), Shanghai Yu King New Material Technology Development Co., Ltd., prepared by complexing 6.5 g iodine and 43.5 g PVP-K30 at 60° C. for 2 hours), high-stability PVPI (YuKing®-PVPI (H), Shanghai Yu King New Material Technology Development Co., Ltd.), potassium iodate (AR), Tween-20 (CP), polyethylene glycol 200 (CP), citric acid (AR), sodium hydroxide (AR). The above mentioned reagents are commercially available. Instruments and equipments:

| Instrument name | Model | Place of origin |
|---|---|---|
| Air blowing thermostatic | DZF-6021 | Shanghai Suopu |
| drying oven | | Instrument Co., Ltd. |
| Electronic analytical balance | FA2004 | Shanghai Liangping |
| | | Instrument Co., Ltd. |
| Alkali burette | 50 ml | Shanghai Heqi Glass |
| | | Instrument Co., Ltd. |

### Embodiment 1

20 g ordinary PVPI prepared by Shanghai Yu King New Material Technology Development Co., Ltd. is dissolved by adding an appropriate amount of water, the pH is adjusted to 5 with 0.2 mol/L sodium hydroxide solution, and the PVPI solution is diluted with water to 200 ml.

### Embodiment 2

20 g high-stability PVPI prepared by Shanghai Yu King New Material Technology Development Co., Ltd. is dissolved by adding an appropriate amount of water, the pH is adjusted to 5 with 0.2 mol/L sodium hydroxide solution, and the PVPI solution is diluted with water to 200 ml.

### Embodiment 3

20 g ordinary PVPI prepared by Shanghai Yu King New Material Technology Development Co., Ltd. is dissolved by adding an appropriate amount of water, in addition 0.5 g potassium iodate, 0.5 g Tween-20, 2.5 g polyethylene glycol 200 and 2.5 g citric acid are dissolved in purified water and added into the PVPI solution, the pH is adjusted to 5 with 0.2 mol/L sodium hydroxide solution, and the PVPI solution is diluted with water to 200 ml and is ready for use.

### Embodiment 4

20 g high-stability PVPI prepared by Shanghai Yu King New Material Technology Development Co., Ltd. is dissolved by adding an appropriate amount of water, in addition 0.5 g potassium iodate, 0.5 g Tween-20, 2.5 g polyethylene glycol 200 and 2.5 g citric acid are dissolved in purified water and added in the PVPI solution, the pH is adjusted to 5 with 0.2 mol/L sodium hydroxide solution, and the PVPI solution is diluted with water to 200 ml and is ready for use.

### Embodiment 5

20 g high-stability PVPI prepared by Shanghai Yu King New Material Technology Development Co., Ltd. is dissolved by adding an appropriate amount of water, in addition 1.0 g potassium iodate, 0.1 g Tween-20, 0.5 g polyethylene glycol 200 and 5.0 g citric acid are dissolved in purified water and added into the PVPI solution, the pH is adjusted to 5 with 0.2 mol/L sodium hydroxide solution, and the PVPI solution is diluted with water to 200 ml and is ready for use.

### Embodiment 6

20 g high-stability PVPI prepared by Shanghai Yu King New Material Technology Development Co., Ltd. is dissolved by adding an appropriate amount of water, in addition 0.1 g potassium iodate, 1.0 g Tween-20, 5.0 g polyethylene glycol 200 and 0.5 g citric acid are dissolved in purified water and added into the PVPI solution, the pH is adjusted to 5 with 0.2 mol/L sodium hydroxide solution, and the PVPI solution is diluted with water to 200 ml and ready for use.

### Embodiment 7: Stability test

The PVPI solutions prepared in Embodiments 1-6 mentioned above are sealed in a plastic bottle respectively, and placed in the air blowing thermostatic drying oven to be accelerated at 85° C. for 15 h, then measured the available iodine content according to the USP method: 2 copies of 20 ml of a sample solution are pipetted accurately and transferred into an iodine flask respectively, and each is titrated with 0.01 mol/L sodium thiosulfate standard solution until the color is light yellow, 2 ml starch indicator is added, and the titration continues until the blue color disappears, the volume of the sodium thiosulfate titration solution used is recorded and the available iodine content of the solution is calculated, and the results are as follows:

Table 1 the available iodine contents and the stabilities of PVPI solutions with pH 5 stored at 85° C. for 15 h

| | Initial | available | changed value |
|---|---|---|---|
| | available iodine | iodine content | of available |
| Number | content (%) | (%) after 15 h | iodine (%) |
| Embodiment 1 | 1.02 | 0.78 | −23.35 |
| Embodiment 2 | 1.02 | 0.97 | −4.35 |
| Embodiment 3 | 1.01 | 0.97 | −3.26 |
| Embodiment 4 | 1.03 | 1.01 | −1.57 |
| Embodiment 5 | 1.03 | 1.01 | −1.95 |
| Embodiment 6 | 1.02 | 1.00 | −1.75 |

Note:
The available iodine content is calculated based on the solution.

For different storage conditions and different pH values have relatively great effects on the stability of the povidone-iodine (PVPI) solution, this experiment adopts the same storage container and the same pH value to investigate the stabilities of two groups of one solution. The results show that only adjusting the pH to 5 with sodium hydroxide is not ideal to the maintaining the stability of the povidone-iodine solution, but when potassium iodate, Tween-20, polyethylene glycol 200, and citric acid are added, the drop of the concentration of the available iodine of the povidone-iodine solution is controlled effectively. The reasons are that: Potassium iodate is an iodine ion inhibitor, when the PVPI reacts reversely, the increasing of the iodine ions can inhibit this reaction, thereby ensuring the stability of the solution; sodium hydroxide is a pH adjusting agent, PVPI itself has a relatively strong acidity, the solution is rather unstable, but when the pH is adjusted to 5 with sodium hydroxide, the stability of the solution can be maintained relatively well.

Therefore, there are two key factors to the preparation of the high-stability PVPI solution: first is to require PVPI powders with good stability; second is to add corresponding additives, the iodine ion stabilizing agent such as potassium iodate, the non-ionic surfactant such as Tween-20, the emulsifier such as polyethylene glycol 200, citric acid, and the pH adjusting agent such as sodium hydroxide during the preparation of the solution. The synergistic effect between the two factors can greatly improve the stability of the solution, which is critical to the long-term storage of the povidone-iodine disinfectant.

To sum up, the stability of the high-stability non-ionic N-vinyl butyrolactam iodine solution of the present invention is high, thereby facilitating long-term storage and use, thus the high-stability non-ionic N-vinyl butyrolactam iodine solution is suitable for large-scale popularization.

In the present specification, the present invention has been described according to the particular embodiments. But it is obvious that these embodiments can be modified or changed without departure from the spirit and scope of the present invention. Therefore, the specification described above is exemplary only and not intended to be limiting.

1. A method of preparing a high-stability N-vinyl butyrolactam iodine solution, where the high-stability N-vinyl butyrolactam iodine meets a condition that the degradation rate after the high-stability N-vinyl butyrolactam iodine is positioned at 85° C. for 15 hours is less than 6.0% of the available iodine in the prepared N-vinyl butyrolactam iodine solution, the method comprising:
dissolving the N-vinyl butyrolactam iodine in water;
then adding the following: citric acid, at least one iodine ion stabilizing agent, at least one non-ionic surfactant, and at least one emulsifier; and
then adjusting pH to 5 with at least one pH adjusting agent, so as to prepare the high-stability N-vinyl butyrolactam iodine solution.

2. The method of preparing a high-stability N-vinyl butyrolactam iodine solution according to claim 1, where the iodine ion stabilizing agent is potassium iodate, the emulsifier is polyethylene glycol 200, and the pH adjusting agent is sodium hydroxide.

3. The method of preparing a high-stability N-vinyl butyrolactam iodine solution according to claim 1, where 20 g of the high-stability N-vinyl butyrolactam iodine is prepared with 0.5-5.0 g of the citric acid, 0.1-1.0 g of the iodine ion stabilizing agent, 0.1-1.0 g of the non-ionic surfactant and 0.5-5.0 g of the emulsifier.

4. The method of preparing a high-stability N-vinyl butyrolactam iodine solution according to claim 1, where the high-stability N-vinyl butyrolactam iodine is formed by complexing PVP-K30 with iodine, and using at least one grinding aid at a temperature of 60° C-90° C.

5. The method of preparing a high-stability N-vinyl butyrolactam iodine solution according to claim 4, where the grinding aid is selected from the group consisting of sodium chloride, sodium citrate, sodium carbonate, and sodium phosphate.

6. The method of preparing a high-stability N-vinyl butyrolactam iodine solution according to claim 4, wherein 46-47 g of said PVP-K30, 7 g of said iodine, and 0.19-0.27 g of said at least one grinding aid are combined.

7. A high-stable N-vinyl butyrolactam iodine solution obtained by the preparation method of a high-stable N-vinyl butyrolactam iodine solution according to claim 1.
